(19) United States
(12) Patent Application Publication
(10) Pub. No.: US 2007/0170903 A1
(43) Pub. Date: Jul. 26, 2007

(54) Active diode bridge system

(75) Inventor: Russell J. Apfel, Austin, TX (US)

Correspondence Address: TOLER SCHAFFER, LLP, 8500 BLUFFSTONE COVE, SUITE A201, AUSTIN, TX, 78759, US

(73) Assignee: Silicon Laboratories, Inc., Austin, TX (US)

(21) Appl. No.: 11/339,955

(22) Filed: Jan. 26, 2006

(51) Int. Cl. G05F 1/00

(52) U.S. Cl. 323/282

(57) ABSTRACT

A powered device includes a diode bridge, a sensed circuit element, and a controller. The diode bridge has a plurality of diodes and at least one bypass element. The diode bridge has a first input terminal and a second input terminal coupled to at least one pair of wires of a powered system. The pair of wires to provides power and data. The controller generates a control signal to selectively activate the at least one bypass element in response to a sensed electrical parameter of the sensed circuit element within the powered device.

### CROSS REFERENCE TO RELATED APPLICATION(S)

This application is related to co-pending U.S. patent application Ser. No. ______, filed on ______, and entitled, “ACTIVE DIODE BRIDGE SYSTEM AND METHOD,” which is incorporated herein by reference in its entirety.

### FIELD OF THE DISCLOSURE

The present disclosure generally relates to powered devices to extract power and to receive data from a powered network.

### BACKGROUND

A diode bridge is an electronic circuit that typically includes an arrangement of diodes that converts either a positive or negative polarity input voltage to a positive polarity output voltage. When used in its most common application, for conversion of alternating current (AC) input into direct current (DC) output, the diode bridge may be referred to as a bridge rectifier. The diode bridge also can provide what is sometimes called “reverse polarity protection.” That is, it permits normal functioning regardless of the polarity of the DC input-power.

Diode bridges typically include four diodes arranged such that current flows across only two of the four diodes in response to an applied voltage or current. Unfortunately, in certain applications where the input voltage and/or the input current is limited, the resultant two-diode voltage drop may be undesirable.

Power over Ethernet (PoE) refers to a technique of transmitting electrical power over twisted-pair cabling, along with data, to remote devices in an Ethernet network. PoE as standardized in IEEE 802.3af provides 44 to 57 volts over at least two-pairs of a four-pair cable at a current of up to 350 mA for a guaranteed load power of approximately 15.4 watts. If the two active diodes of a diode bridge rectifier circuit each contribute a voltage drop of approximately 0.8 volts, the diode bridge consumes approximately three percent of the available power. Moreover, depending on the type of diode used, the voltage drop may be greater, resulting in greater power consumption in the diode bridge.

Conventionally, diode bridges and other power-related circuits are provided separately from logic circuitry in order to isolate the logic circuitry from heat generated by the power-related circuits and to address substrate biasing issues. However, such separate circuits increase unit cost for the overall system. Therefore, there is a need for a low-power bridge diode circuit that can be produced at a lower unit cost.

### SUMMARY

In one embodiment, a powered device includes a diode bridge, a sensed circuit element, and a controller. The diode bridge has a plurality of diodes and at least one bypass element. The diode bridge has a first input terminal and a second input terminal coupled to at least one pair of wires of a powered system to provide power and data. The controller generates a control signal to selectively activate the at least one bypass element in response to a sensed electrical parameter of the sensed circuit element within the powered device.

In another embodiment, a powered device has a diode bridge, two transformers, and a controller. The diode bridge includes a plurality of diodes and at least one diode bypass element associated with at least one of the plurality of diodes. The diode bridge comprising two input terminals and two output terminals. The two transformers are coupled to a powered network. Each of the two transformers have a center tap coupled to a respective one of the two input terminals of the diode bridge. The controller determines an electrical parameter of the diode bridge and generates a control signal to activate the at least one diode bypass element in response to determining the electrical parameter.

In another embodiment, a powered device has a first transformer, a second transformer, a diode bridge, and a controller. The first transformer is coupled to wiring of a powered network, which provides power and data. The first transformer includes a center tap. The second transformer is coupled to the wiring of the powered network and includes a center tap. The diode bridge includes a plurality of diodes and at least one diode bypass element associated with at least one of the plurality of diodes. The diode bridge has a first input terminal coupled to the center tap of the first transformer and has a second input terminal coupled to the center tap of the second transformer. The controller determines an electrical parameter of the diode bridge and selectively activates the at least one diode bypass element in response to the electrical parameter.

In another embodiment, a powered device extracts power and receives data from a network cable. The powered device includes a diode bridge, a sensed circuit element, and a controller. The diode bridge has a plurality of diodes and at least one bypass element and has input terminals to receive a voltage supply. The diode bridge is coupled to a powered system via the network cable. The circuit element is coupled to at least a portion of the diode bridge. The controller generates a control signal to selectively activate the at least one bypass element in response to a sensed electrical parameter of the circuit element.

### BRIEF DESCRIPTION OF THE DRAWINGS

The present disclosure may be better understood, and its numerous features and advantages made apparent to those skilled in the art by referencing the accompanying drawings.

FIG. 1 is a block diagram of a system with a Power over Ethernet (PoE) power sourcing equipment (PSE) device and PoE powered devices (PDs).

FIG. 2 is a block diagram illustrating a wiring interconnection between a PoE source and a powered device.

FIG. 3 is a circuit diagram of a low-power diode bridge circuit with a controller.

FIG. 4 is a circuit diagram of an alternate embodiment of a low-power diode bridge circuit with a controller.

FIG. 5 is a block diagram of a power circuit with two diode bridges and their associated controllers.

FIG. 6 is a block diagram of a power circuit with two diode bridges with a common controller adapted to control both diode bridges.

FIG. 7 is a block diagram of an embodiment of a controller.

FIG. 8 is a flow diagram of a method of operating a diode bridge by activating a diode bypass element.

FIG. 9 is a flow diagram of a method of deactivating a diode bypass element.

### DETAILED DESCRIPTION OF THE DRAWINGS

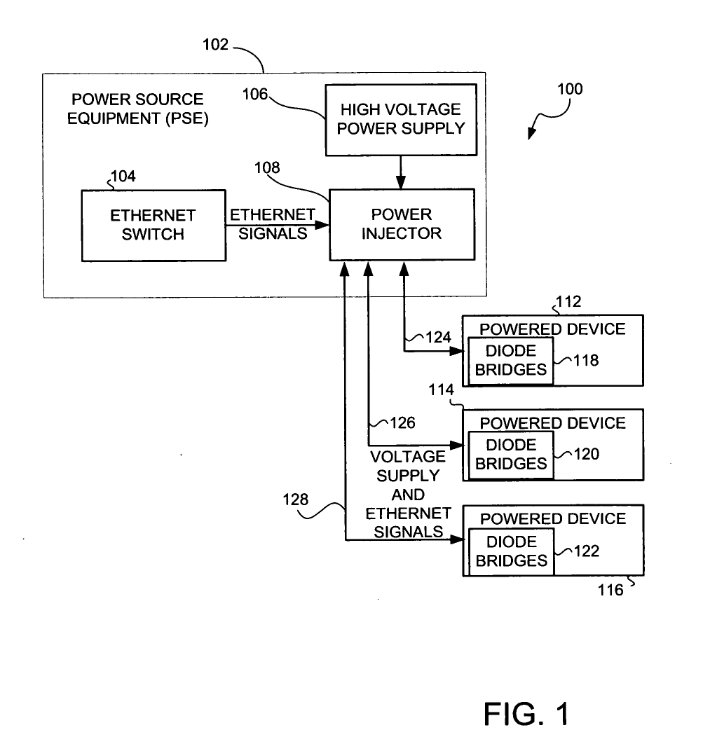

FIG. 1 is a block diagram of system 100 with a power over Ethernet (PoE) power source equipment (PSE) device 102 and powered devices. In this particular implementation, the PSE device 102 includes an Ethernet switch 104, a high voltage power supply 106, and a PoE injector 108. The system 100 also includes PoE powered devices (PDs) 112, 114 and 116 with respective diode bridges 118, 120, and 122. The PSE device 102 is communicatively coupled to the PDS 112, 114, and 116 via twisted pair cabling 124, 126, and 128. In general, the system 100 may also include network devices (not shown) that are not adapted for PoE, which may draw power from a separate power supply, such as an electrical wall plug.

The high voltage power supply 106 provides a supply voltage to the power injector 108. The power injector receives Ethernet signals from the Ethernet switch 104 and places the Ethernet signals and at least a portion of the supply voltage onto Ethernet cables 124, 126 and 128. The PoE hub 110 can power a number of PDs depending on the specific implementation. Each powered device 112, 114 and 116 may include one or more diode bridges 118, 120 and 122 respectively. In general, in many applications, such as telephony and PoE, due to wiring uncertainties, the polarity of the input supply voltage at the PD cannot be guaranteed. The diode bridges 118, 120 and 122 provide that the correct voltage polarity is applied to load electronics within the PD or to electronic devices attached to the PD.

In general, the term “powered device” and “PD,” as used herein, refers to a device adapted to receive a power supply and to receive data from the same cable or wiring. In the embodiment shown, the PDs 112, 114 and 116 are adapted to operate within a PoE environment. Alternatively, the power sourcing equipment (PSE) may be any source adapted to transmit power and data over common wiring. For example, the PSE may be an electrical power transmission station adapted for high speed broadband data transmissions over electrical transmission lines. In such an instance, the data transmissions may use data packets, may use data frames, may use other data protocols, or any combination thereof. Nevertheless, the PDs 112, 114, and 116 may be adapted to communicate using an appropriate protocol, and the active diode bridges 118, 120 and 122 can be used to provide low loss rectification of the power supply.

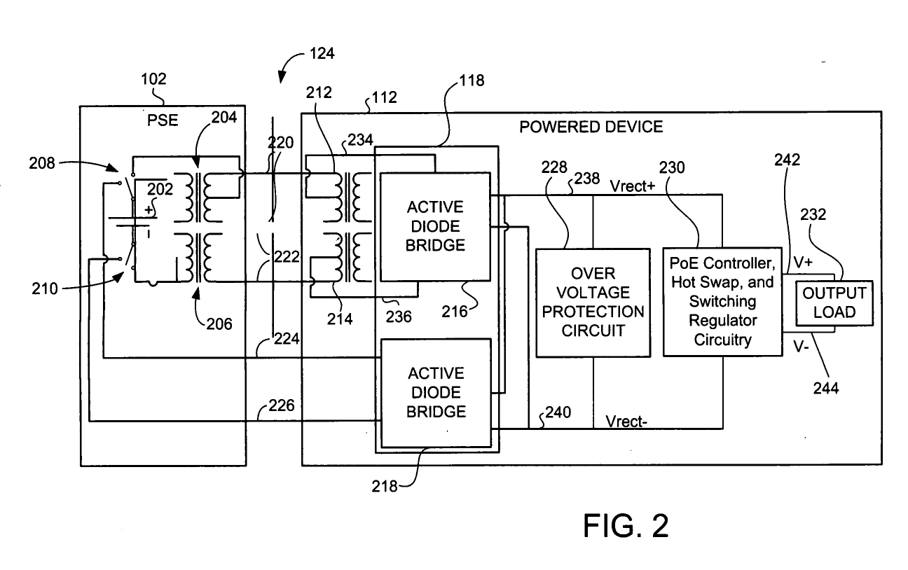

FIG. 2 is a block diagram illustrating a wire interconnection between an illustrative PSE device 102 and an illustrative PD 112. The PSE device 102 and the PD 112 are connected via Ethernet cable 124. In general, the Ethernet cable 124 is comprised of a plurality of wire pairs 220, 222, 224, and 226. The IEEE 802.3AF standard defines a role for each of the wire pairs 220, 222, 224 and 226 within the twisted pair wiring 124. Two of the wire pairs 220 and 222 carry Ethernet packets, and two of the wire pairs 224 and 226 are spares.

The PSE device 102 includes a power supply 202, which is used to power windings of the transformers 204 and 206, which place power onto the wire pairs 220 and 220 of the twisted pair cable 124. In this implementation, the PSE device 102 is coupled to the transformers 204 and 206 through switches 208 and 210. The switches 208 and 210 may couple the power supply 202 to the transformers 204 and 206 or may couple the power supply 202 directly to wire pairs 224 and 226 (sometimes referred to as the spare pare).

The PD 112 includes diode bridges 118, transformers 212 and 214, an over-voltage protection circuit 228, and a PoE controller/hot swap/switching regulator circuit 230, which provides power to an output load 232. The diode bridges 118 include active diode bridge 216 and active diode bridge 218. Each of the active diode bridges 216 and 218 include two inputs for receiving an input voltage supply and two outputs for providing a rectified voltage supply (V_{rect}+ and V_{rect}−). In general, the transformers 212 and 214 are connected to wire pairs 220 and 222 to receive data signals and power from the PSE 102. The transformers 212 and 214 are connected via their respective center taps 234 and 236 to the inputs of the active diode bridge 216. By connecting to the respective center taps 234 and 236, data can be extracted from the signal at a common mode of the transformers 212 and 214. The wire pairs 224 and 226 are connected to the inputs of the active diode bridge 218. The outputs of the diode bridges 216 and 218 are connected to input voltage supply terminals 238 and 240. The diode bridges 216 and 218 provide a positive rectified voltage (Vrect+) onto the input voltage supply terminal 238 and a negative rectified voltage (Vrect−) onto the input voltage supply terminal 240. The over-voltage protection circuit 228 is connected between the input voltage supply terminals 238 and 240, to detect an over-voltage condition and to protect the PoE controller/hot swap/switching regulator circuit 230 as well as the output load 232 from over-voltage faults. Additionally, the PoE controller/hot swap/switching regulator circuit 230 is connected between the input voltage supply terminals 238 and 240. When the supply voltage levels on the input voltage supply terminals 238 and 240 are within an expected voltage supply range (such as between 36 and 57 volts), the PoE controller/hot swap/circuit 230 provides a DC voltage supply to the output load 232 via the supply terminals 242 and 244.

During operation, two of the wire pairs, such as wire pairs 220 and 222 or wire pairs 224 and 226, may be used to provide an input supply voltage to the PD 112. It is typically not known which of the pairs of wires will be used. Consequently, the PD 112 is adapted to receive a supply voltage from either set of wire pairs.

The active diode bridges 216 and 218 include diode bypass elements (diode bypass switches) placed in parallel with at least one of the diodes within each of the diode bridges 216 and 218. Under certain conditions, a selected one of the diode bypass elements within one of the diode bridges 216 and 218 is activated to provide a current path to bypass the associated diode within the respective diode bridge 216 or 218. The diode bypass element reduces the voltage consumption within the diode bridge by routing current through the bypass element to bypass the associated diode. From a power perspective, the diode bypass element looks like a low value resistor when it is active. The bypass current flows through the diode bypass element as long as the voltage drop across the bypass element is less than a turn on voltage of the diode. In one embodiment, the diode bypass element is a field effect transistor (FET). Since an active FET can sink a large amount of current at low voltage, the diode can remain inactive. By applying a transistor bypass to a full diode bridge 208 or 210 to bypass selected diodes within the diode bridge, the overall power consumption of the diode bridge is reduced, thereby reducing the overall load and improving the power efficiency of the PD 112. Alternatively, the diode bypass element may be a bipolar transistor.

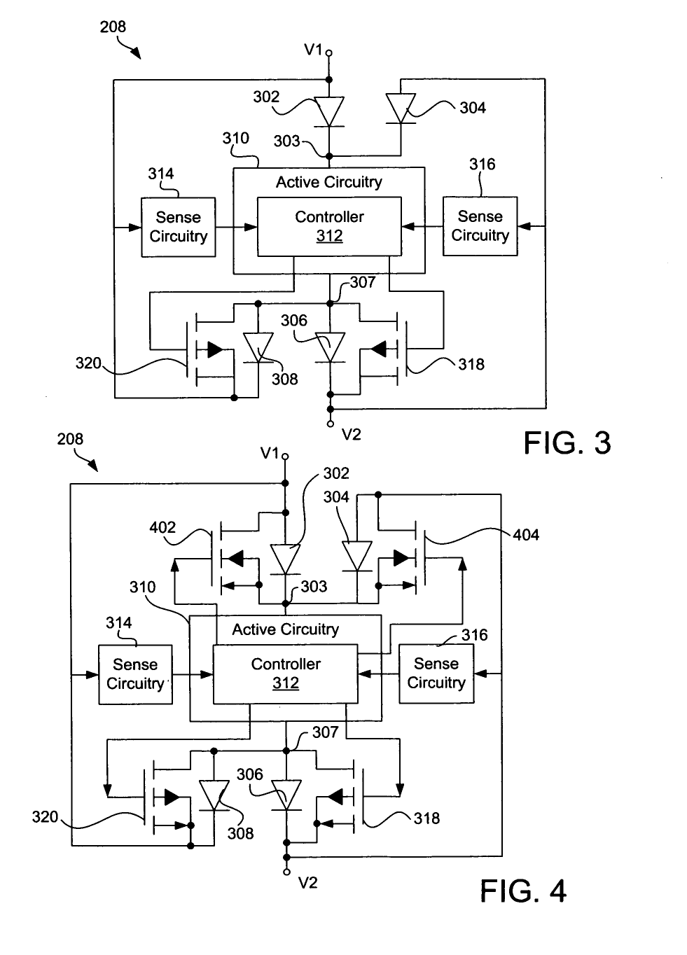

FIG. 3 is a circuit diagram of a particular illustrated embodiment of the active diode bridge 208. The diode bridge 208 includes a first diode 302, having an anode terminal coupled to a first voltage supply terminal (V1) and a cathode terminal coupled to node 303, which is the positive output supply voltage terminal of the diode bridge 208. The diode bridge 208 also includes a second diode 304 having an anode coupled to a second voltage supply terminal (V2) and a cathode coupled to the node 303. A third diode 306 has an anode coupled to node 307, which is a negative output supply voltage terminal for the load from the diode bridge 208, and a cathode coupled to the second voltage source (V2). A fourth diode 308 has an anode coupled to the node 307 and a cathode coupled to the first voltage source (V1). Diodes 302, 304, 306 and 308 form a full diode bridge.

The diode bridge 208 also includes active circuitry 310 including a controller 312 coupled between the positive and negative output supply voltage terminals and including sense circuitry 314 and 316. The diode bridge 208 also includes a pair of diode bypass elements, such as bypass transistors 318 and 320. The transistor 318 is connected between the node 307 and the second voltage supply terminal (V2), in parallel with the third diode 306. The transistor 320 is connected between the node 307 and the first voltage supply terminal (V1), in parallel with the fourth diode 308. In particular, the bypass transistor 318 has a first terminal coupled to node 307, a gate coupled to a first output of the controller 312 and a second terminal coupled to the second voltage source (V2). The bypass transistor 320 has a first terminal coupled to the node 307, a gate coupled a second output of the controller 312, and a second terminal coupled to the first voltage source (V1). The bypass transistors 318 and 320 provide bypass current paths for current to bypass the diodes 306 and 308, respectively.

The controller 312 is capable of measuring an electrical characteristic of the sense circuitry 314 and 316 and may generate a control signal to activate one, but not both, of the bypass transistors 318 and 320 in response to the measured electrical characteristic. In particular, the controller 312 may generate a control signal when the measured electrical characteristic exceeds a threshold. The threshold can be a user-defined parameter, a programmable parameter, or a user-adjustable parameter, depending on the particular implementation. In one embodiment, the controller 312 generates a control signal to activate one of the bypass transistors when the measured electrical characteristic is less than the threshold. In an alternative embodiment, the controller 312 generates a first control signal to activate one of the bypass transistors and a second control signal to deactivate the other bypass transistor in response to the measured electrical characteristic being greater than or less than the threshold. Additionally, the controller 312 may have an input terminal adapted to receive a signal from other components of the active circuitry 310. The active circuitry 310 can perform logical operations on signals derived from the sense circuitry 314 and 316, and the controller 312 can selectively activate or deactivate the bypass transistors 318 and 320 according to the received signal from the active circuitry 310.

The diode bridge 208 provides full wave rectification of an input voltage. When powered up, two diodes are forward biased and two are reverse biased. For example, if first voltage source (V1) has a higher voltage potential than the second voltage source (V2), the first diode 302 and the second diode 306 are forward biased to provide an output supply voltage to active circuitry 310, as well as to other circuitry coupled to the output voltage supply terminals 303 and 307 of the diode bridge 208. The active circuitry 310 via the controller 312 uses the sense circuitry 316 and 314 to detect an electrical characteristic of the diode bridge 208. When the electrical characteristic indicates that the diodes 302 and 306 are active, the controller 312 generates a control signal to activate the bypass transistor 318 to provide a current path to bypass the diode 306. The current is diverted from the diode 306 through the transistor 318. In general, by bypassing diode 306, the diode bridge 208 reduces the voltage drop across the diodes in the diode bridge 208 to reduce power dissipation and improve overall efficiency. By reducing power consumption in the diode bridge 208, more power is made available for use elsewhere in the circuitry of the powered device. Such reduced power dissipation may allow for the use of lower cost integrated circuit packages.

Alternatively, if the first voltage source V1 has a lower electrical potential than the second voltage source V2, then diodes 304 and 308 are active. The active circuitry 310 uses the controller 312 and sense circuitry 314 and 316 to detect an electrical characteristic of the diode bridge 112 and to generate a control signal to bypass transistor 320 in response to the detected electrical characteristic. In one embodiment, the electrical characteristic is a voltage drop across the sense circuitry 314 and/or 316. In an alternative embodiment, the electrical parameter is a current level. In another embodiment, the electrical characteristic is an inductance, a complex inductance, an impedance, a complex impedance, a capacitance, or any other suitable electrical characteristic.

Depending on the implementation, sense circuitry 314 and 316 may be a sense resistor, a capacitor, or another active or passive circuit element, other than the diodes 302, 304, 306 and 308. In one embodiment, sense circuitry 314 and 316 comprise capacitors, and the controller 312 is adapted to monitor a change in capacitance and or a complex impedance of a capacitive element to determine which of the bypass transistor 318 or 320 to activate. In one embodiment, a capacitive element can be formed by placing an electrical lead proximate to each of the current paths, and current flow within each of the current paths is detectable as a change in capacitance or a complex impedance measured from the electrical lead. In an alternative embodiment, a current loop is provided that extends from and terminates on the controller 312 and is disposed adjacent to one of the current paths. In this instance, the current loop can be used to detected current flowing in one of the current paths based on a change in a complex impedance within the current loop.

Generally, the bypass transistors 318 and 320 may be field effect transistors (FET), such as metal-oxide semiconductor FETs (MOSFETs). Alternatively, the transistors 318 and 320 can be Junction FETs (JFETS) or bipolar transistors. Alternatively, other types of switching components can be used to bypass selected diodes within the diode bridge, provided the switching components can be selectively activated or deactivated and provided that the switching component provides a lower voltage drop than the associated diode.

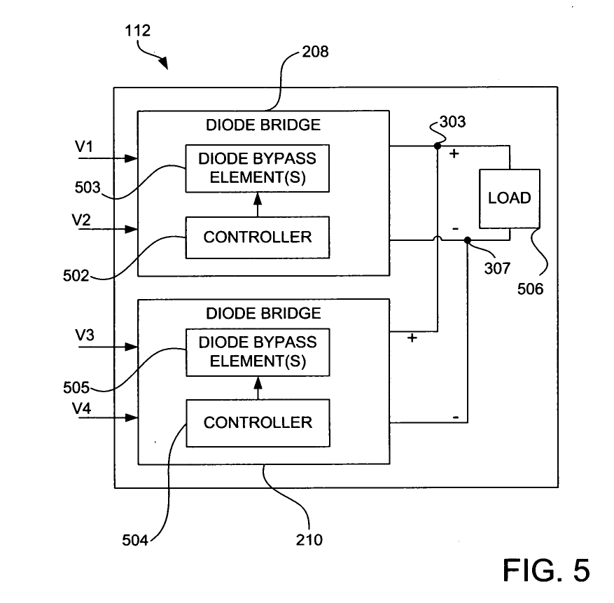

FIG. 4 is a circuit diagram of an alternative embodiment of the active diode bridge 208. In general, the structure of the active diode bridge 208 is similar to the diode bridge 208 in FIG. 3; however, additional bypass transistors 402 and 404 are coupled across the first and second diodes 302 and 304, respectively. In particular, the transistor 402 includes a first terminal coupled to an anode of diode 302, a gate terminal coupled to the controller 312, and a second terminal coupled to a cathode of diode 302. The transistor 404 includes a first terminal coupled to an anode of the diode 304, a gate coupled to the controller 312, and a second terminal coupled to a cathode of diode 304. In this embodiment, the controller 312 is adapted to generate control signals to selectively activate at least two, but not all, of the bypass transistors 318, 320, 402 and 404 in an active current path.

For example, when a first voltage source (V1) has a greater voltage potential than the second voltage source (V2), the controller 312 activates transistors 402 and 318 to bypass the diodes 302 and 306, respectively. By bypassing the diodes 302 and 306, the current flows through the transistors 402 and 318 to rectify the input voltage without losing two diode voltage drops. When the polarity of the input supply voltages is reversed, the transistors 404 and 320 are activated to bypass the diodes 304 and 308, respectively.

The controller 312 is adapted to measure an electrical characteristic of the sense circuitry 314 and 316 and to generate a control signal to activate at least two, but not all, of the bypass transistors 318, 320, 402 and 404 in response to the measured electrical characteristic. In particular, the controller 312 may generate a control signal when the measured electrical characteristic exceeds or falls below a threshold. The threshold can be a user-defined parameter, a programmable parameter, or a user-adjustable parameter, depending on the particular implementation. The parameter may also be defined by electrical characteristics of a discrete circuit component, such as a breakdown voltage of a diode. In one embodiment, the controller 312 generates a control signal to activate two of the bypass transistors when the measured electrical characteristic is less than the threshold. In an alternative embodiment, the controller 312 generates a first and a second control signal to activate two of the bypass transistors and a third and a fourth control signal to deactivate the other bypass transistors in response to the measured electrical characteristic being greater than or less than the threshold.

The diode/FET combinations shown in FIGS. 3 and 4 can be implemented with a separate diode and a separate FET, or with a single FET using a body diode of the FET as the forward diode. If the body diode is used in place of a separate diode, the FET is to be operated in the reverse direction with the source and the drain effectively reversed from normal operation.

In order to turn on the transistors to bypass the diodes within the diode bridge, the supply voltage must exceed a threshold voltage, set by the FET threshold voltage, or an internal charge pump circuit may be used. Within the POE environment, the power requirements are tightly controlled, so the diode is used for lower power dissipation, which remains very low until the supply voltage reaches a voltage much higher than the transistor threshold. Therefore, the FET transistor devices can be held inactive until the input voltage exceeds a fixed threshold and/or the input current exceeds a threshold. For example, in a POE application, a threshold of 30 volts input or a current of 100 milliamps may be desirable.

The specific design of the diode and bypass transistor is technology dependent. Typical N-channel transistor devices have lower “on resistance” than typical P-channel devices. The voltage drop (Rₒₙ*Iₘₐₓ) should be lower than the diode voltage drop in order for the bypass to function properly. The parallel FET and diode use more silicon area than a diode alone, so the bypass diode bridge is more expensive to implement in terms of silicon area on an integrated circuit. Consequently, a designer may decide between a proper trade off between cost and lower power.

In PoE applications, the input voltage differential typically ranges from between 36 volts and 54 volts, and the current typically ranges between 0 milliamps and 400 milliamps. The IEEE 802.3AF standard specifies a voltage of between 44 and 57 volts and a current of up to 350 milliamps. Typically, diode drops at 400 milliamps are about 0.9 volts resulting in approximately 720 milliwatts (mW) of power dissipated in the diodes. When activated, the controllable bypass elements approximate low value resistors, such as a 1-Ohm resistor. Such a bypass element with approximately a 1-Ohm impedance can reduce overall power consumption within the diode bridge by about 400 mW to 320 mW. Moreover, lower values of impedance can reduce power consumption even further. However, in some instances, such lower value impedance devices may be more expensive to produce, so a designer may need to make a cost/benefit assessment in terms of the desired power savings versus the overall cost. Depending on the specific implementation, due to cost and performance considerations, only two bypass elements may be provided (one in each possible current path).

FIG. 5 is a circuit diagram of a PD 112 with two diode bridges 208 and 210, and associated controllers 502 and 504 and diode bypass elements 503 and 505. The diode bridges 208 and 210 of the PD 112 are coupled to four input voltage sources, V1, V2, V3 and V4. The diode bridge 208 is coupled to the supply voltage terminals V1 and V2, and the diode bridge 210 is coupled to the supply voltage terminals V3 and V4. The controller 502 within the diode bridge 208 is adapted to monitor an electrical characteristic associated with the diode bridge 208 and to generate one or more control signals to selectively activate at least one bypass element 503 in-line with an active current path in order to reduce power consumption within the diode bridge 208. Similarly, the controller 504 is provided within the diode bridge 210 in order to selectively activate at least one bypass element 505 in-line with an active current path of the diode bridge 210. One or both of the diode bridges 208 and 210 may provide an output supply voltage to the load 506, which can include both active and passive circuitry, as well as electronic circuitry of devices coupled to the PD. In one embodiment, the load 506 is provided on the same integrated circuit as the diode bridges 208 and 210.

In the embodiment shown, the diode bridges 208 and 210 each have their own controller 502 and 504, respectively. The controllers 502 and 504 monitor at least one electrical characteristic or parameter of the associated diode bridge 208 and 210. For example, in one embodiment, sense resistors are provided between the active current path and the controllers 502 and 504 to detect current flow. The controllers 502 and 504 monitor one or more electrical characteristics of the sense resistor and activate one or more of the diode bypass elements 503 and 505 in response to at least one of the one or more sensed characteristics. In an alternative embodiment, an electrical lead may be provided proximate to a portion of the diode bridge, and the controllers 502 and 504 can be adapted to monitor a change in inductance, impedance, or capacitance in that lead.

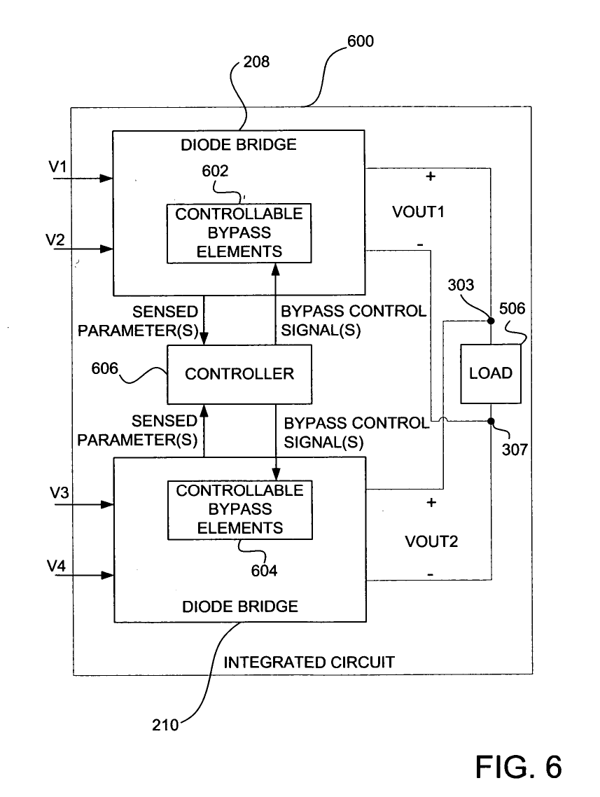

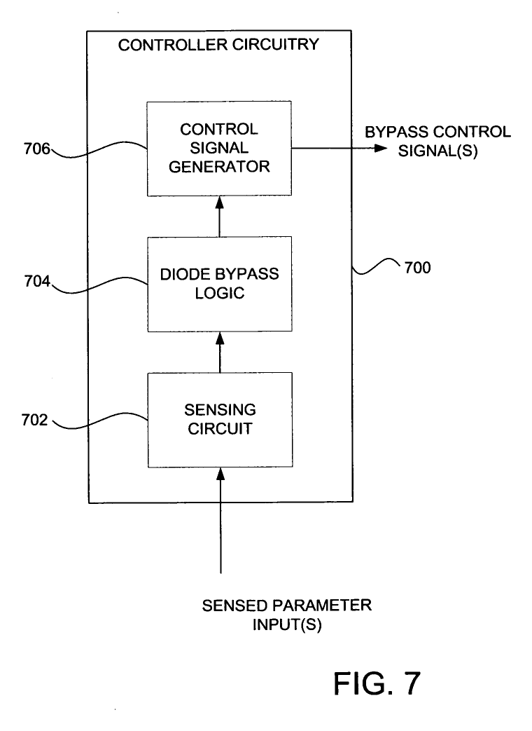

FIG. 6 is a circuit diagram of an illustrative PD 600 with two diode bridges 208 and 210 and a common shared controller 606 (central controller 606). The diode bridge 208 includes two or more controllable bypass elements 602. The diode bridge 208 is adapted to receive a first voltage potential from a first supply voltage terminal (V1) and a second voltage potential supply voltage potential from a second supply voltage terminal (V2). The central controller 606 is adapted to receive a signal associated with an electrical parameter or characteristic of the diode bridge 208 and to generate control signals to selected ones of the controllable bypass elements 602 within the diode bridge 208 to activate the selected controllable bypass elements 602. In one embodiment, the central controller 606 provides an activation control signal to at least one controllable bypass element of the controllable bypass elements 602 within an active current path and a deactivation control signal to at least one controllable bypass element of the controllable bypass elements 602 that is not in the active current path. The diode bridge provides a rectified output supply voltage (Vout1) that can provide power to the load 506.

The diode bridge 210 is provided with controllable bypass element 604. The diode bridge 210 is adapted to receive a first supply voltage potential from a first supply voltage terminal (V3) and a second supply voltage from a second supply voltage terminal (V4). The diode bridge 210 is coupled to the central controller 606. The central controller 606 is adapted to receive a signal related to an electrical parameter or characteristic of the diode bridge 210 and to generate bypass control signals to the controllable bypass elements 604 to selectively activate one or more of the controllable bypass elements in response to the electrical parameter. The diode bridge 210 provides an output supply voltage (Vout2) for providing a power supply to the load 506. In one embodiment, the load 506, the diode bridges 208 and 210 and the central controller 606 are fabricated or disposed on a single integrate circuit. The load 506 can include active logic, passive circuit components, processors, and the like.

The central controller 606 is adapted to monitor the diode bridges 208 and 210. While only two diode bridges 208 and 210 are shown, it should be understood that more than two diode bridges may be used within an electronic device and that the central controller 606 may monitor each of the diode bridges and may generate control signals to respective diode bypass elements to selectively activate and/or deactivate the diode bypass elements within a current path of each the respective diode bridges. For example, the central controller 606 is coupled to the diode bridges 208 and 210. The central controller 606 has a first output to provide a first control signal to selectively activate at least one bypass element of the controllable bypass elements 602 within the diode bridge 208 and a second output to provide a second control signal to selectively activate at least one bypass element of the controllable bypass elements 604 within the diode bridge 210. The central (shared) controller 606 can selectively activate the at least one bypass element of the controllable bypass elements 602 based on a measured level of an electrical parameter or characteristic of the diode bridge 208. Similarly, the controller 606 can selectively activate the ate least one bypass element of the controllable bypass elements 604 based on a measured level of an electrical characteristic of the diode bridge 210.

Additionally, though the central controller 606 is illustrated as being centered within the integrated circuit 600, it should be understood that the central controller 606 can be positioned anywhere within the circuit 600.

The controller 606 is capable of making decisions about which of the bypass elements to activate at any given time. If four bypass elements are provided within a diode bridge, the control circuit senses an electrical characteristic of the diode bridge before turning on two of the four bypass elements (both within the active current path). In one embodiment, since the voltage supplies are direct current supplies, the controller may be adapted to deactivate two or more of the transistor bypass elements when the current falls below a threshold. By deactivating bypass elements when the current is below a threshold, the controller 606 may activate the proper bypass elements.

FIG. 7 is a block diagram of an embodiment of a controller that may be used in connection with the circuits shown in FIGS. 3-6. The controller 700 includes a sensing circuit 702 adapted to receive a signal related to a sensed electrical characteristic or parameter of the diode bridge. The controller 700 also includes diode bypass logic 704 and a control signal generator 706. The diode bypass logic 704 determines which diodes are active based on the received signal related to the sensed electrical characteristic of the diode bridge. The control signal generator 706 generates a bypass control signal to selected ones of the bypass control elements based on the determined active diodes of the diode bridge.

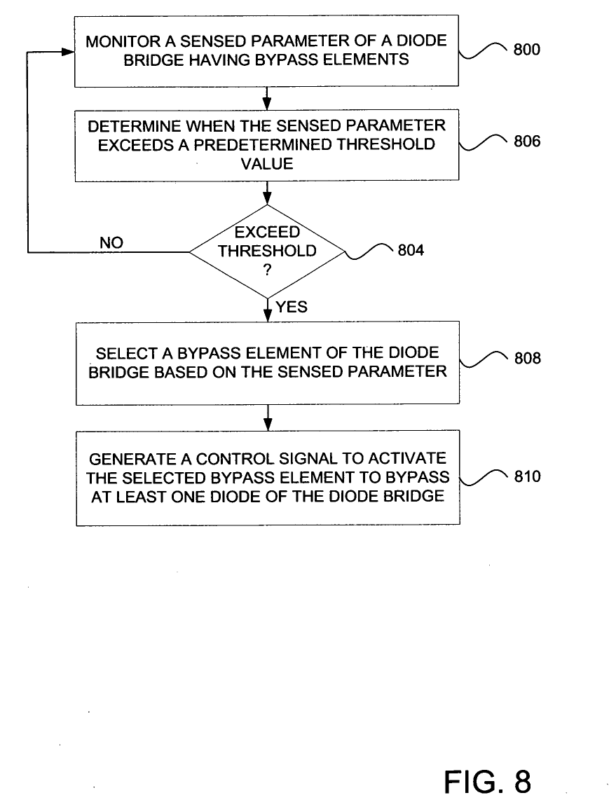

FIG. 8 is a flow diagram of a method of operating a diode bridge by activating a diode bypass element. A sensed parameter of a diode bridge having bypass elements is monitored (block 800). A controller determines when the sensed parameter exceeds a predetermined threshold value (block 806). If the sensed parameter does not exceed the threshold (block 804), the controller continues to monitor the sensed parameter until the predetermined threshold value is exceeded. If the predetermined threshold value is exceeded (block 804), the controller selects a bypass element of the diode bridge based on the sensed parameter (block 808). The controller then generates a control signal to activate the selected bypass element to bypass at least one diode of the diode bridge (block 810).

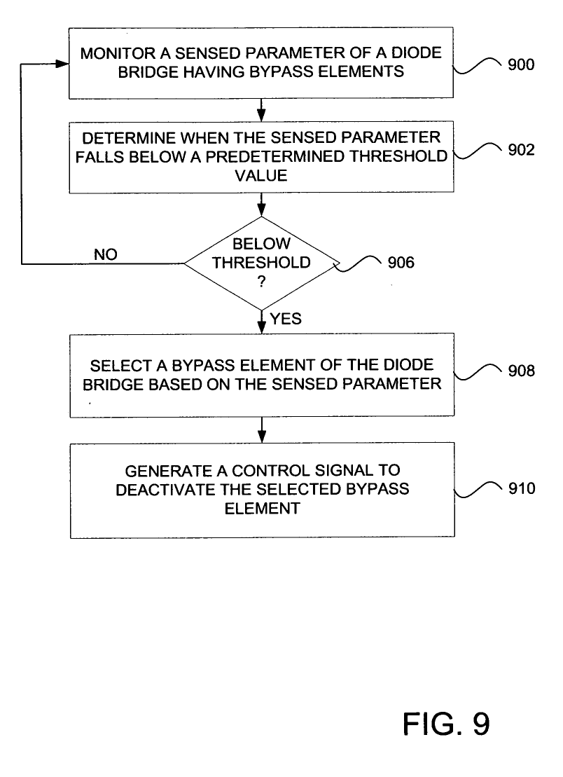

FIG. 9 is a flow diagram of a method of deactivating a diode bypass element. The controller monitors a sensed parameter of a diode bridge having bypass elements (block 900). The controller determines when the sensed parameter falls below a predetermined threshold value (block 902). If the sensed parameter does not fall below the predetermined threshold value (block 906), then the controller continues monitoring the sensed parameter until it falls below the predetermined threshold value. If the sensed parameter falls below the predetermined threshold value (block 906), the controller selects a bypass element of the diode bridge based on the sensed parameter (block 908) and generates a control signal to deactivate the selected bypass element (block 910).

In general, the controller is adapted to monitor an electrical characteristic of one or more diode bridges and may generate a control signal to one or more diode bypass elements within the one or more diode bridges in response to the monitored electrical characteristic. The electrical characteristic can be a current, a voltage, complex impedance, a complex inductance, and/or any other suitable electrical parameter. In a particular embodiment, the electrical characteristic is monitored using a circuit component that is not in-line with the active current path, such as a sense resistor, a bond-wire inductor, a capacitive lead, a capacitor, an inductor, or any other suitable circuit element. In a particular embodiment, the electrical characteristic may be processed by logic within the load or within other active circuitry and the controller can use a signal received from the logic, the load, or other active circuitry to selectively activate one or more diode bypass elements.

Conventionally, diode bridges for power supply inputs are implemented as separate circuits to an integrated circuit due to substrate biasing issues. However, the introduction of low cost silicon on insulator technologies with oxide isolation reduces the substrate issues and makes integration of diode bridges with other low power circuit components possible.

In general, though the embodiments described above have focused largely on PoE implementations, it should be understood that the active diode bridge may be utilized in other applications where low loss rectification is desired. Moreover, the above-described embodiments may be employed with other types of powered networks, where the power supply voltage cabling also carries data. For example, active diode bridges may be used to rectify a voltage supply from a bus including power and data. Alternatively, the active diode bridges may be used to rectify a voltage supply from electrical power lines that also carry data transmissions. In such an instance, a diode bridge may be used in conjunction with transformers (such as transformers 212 and 214 in FIG. 2) to rectify the voltage, to extract data from the power supply, and to provide isolation for the internal electronics of the powered device. In general, a powered device with one or more active diode bridges may be adapted to derive power and to receive data from the same wire, wire pair, or alternative communication link, regardless of the network type. In some embodiments, the wiring that couples the powered network to the powered device may include a plurality of individual wires, such as twisted pair cabling. In such instances, a pair of individual wires may carry both power and data. Alternatively, a first pair of the individual wires may carry data and a second pair of the individual wires may carry a supply voltage. In another embodiment, the wiring may include a power bus that carries both power and data. In another embodiment, the wiring may include a coaxial cable that carries both power and data.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A powered device comprising:
a diode bridge comprising a plurality of diodes and at least one bypass element, the diode bridge having a first input terminal and a second input terminal, the first input terminal and the second input terminal coupled to at least one pair of wires of a powered system, the pair of wires to provide power and data;
a sensed circuit element; and
a controller to generate a control signal to selectively activate the at least one bypass element in response to a sensed electrical parameter of the sensed circuit element within the powered device.

2. The powered device of claim 1, wherein the at least one pair of wires is provided by a twisted pair cable and wherein the powered system is adapted to provide power over Ethernet (PoE) power and data over the twisted pair cable.

3. The powered device of claim 1, further comprising:
a first transformer coupled to a first wire pair of the at least one pair of wires, the first transformer including a first center tap coupled to the first input terminal; and
a second transformer coupled to a second wire pair of the at least one pair of wires, the second transformer including a second center tap coupled to the second input terminal.

4. The powered device of claim 3, wherein the first wire pair and the second wire each pair provide power and data.

5. The powered device of claim 1, wherein the sensed circuit element is coupled to the diode bridge.

6. The powered device of claim 1, further comprising a low power module coupled to an output terminal of the diode bridge, wherein the diode bridge and the controller are disposed within a high power module.

7. A powered device comprising:
a diode bridge including a plurality of diodes and at least one diode bypass element associated with at least one of the plurality of diodes, the diode bridge comprising two input terminals and two output terminals;
two transformers coupled to a powered network, each of the two transformers having a center tap coupled to a respective one of the two input terminals of the diode bridge; and
a controller to determine an electrical parameter of the diode bridge and to generate a control signal to activate the at least one diode bypass element in response to determining the electrical parameter.

8. The powered device of claim 7, wherein the powered network comprises a power over Ethernet (PoE) network.

9. The powered device of claim 7, wherein the powered network comprises an electrical power line.

10. The powered device of claim 7, wherein the two transformers are adapted to receive a supply voltage potential within a range of 35 volts to 57 volts.

11. The powered device of claim 7, wherein the electrical parameter comprises a voltage level between the two input terminals.

12. A powered device comprising:
a first transformer coupled to wiring of a powered network, the powered network providing power and data, the first transformer including a center tap;
a second transformer coupled to the wiring of the powered network, the second transformer including a center tap;
a diode bridge comprising a plurality of diodes and at least one diode bypass element associated with at least one of the plurality of diodes, the diode bridge comprising a first input terminal coupled to the center tap of the first transformer and a second input terminal coupled to the center tap of the second transformer; and
a controller to determine an electrical parameter of the diode bridge and to selectively activate the at least one diode bypass element in response to the electrical parameter.

13. The powered device of claim 12, wherein the electrical parameter comprises a voltage level across a selected one of the plurality of diodes.

14. The powered device of claim 12, further comprising a sensed circuit element, and wherein the controller is adapted to determine the electrical parameter of the sensed circuit element.

15. The powered device of claim 12, wherein the powered network comprises a power over Ethernet (PoE) network.

16. The powered device of claim 15, wherein the wiring comprises a twisted pair cable.

17. The powered device of claim 12, wherein the powered network comprises electrical power lines to supply power and to carry broadband data transmissions.

18. The powered device of claim 12, wherein the powered network provides a voltage potential within a range of 35 to 57 volts.

19. The powered device of claim 12, wherein the powered network provides a current level up to 4 mA.

20. The powered device of claim 12, wherein the powered network comprises a bus including power and data.

21. A powered device to extract power and to receive data from a network cable, the powered device comprising:
a diode bridge comprising a plurality of diodes and at least one bypass element, the diode bridge having input terminals to receive a voltage supply, the diode bridge coupled to a powered system via the network cable;
a circuit element coupled to at least a portion of the diode bridge; and
a controller to generate a control signal to selectively activate the at least one bypass element in response to a sensed electrical parameter of the circuit element.

22. The powered device of claim 21, wherein the diode bridge is adapted to provide a rectified voltage in response to the voltage supply, the rectified voltage comprising a voltage level that is less than two diode voltage drops from a level of the voltage supply.

23. The powered device of claim 21, wherein the sensed electrical parameter comprises a voltage.

24. The powered device of claim 21, wherein the powered system comprises an electrical power network.

25. The powered device of claim 21, wherein the powered system comprises a data bus with a power supply.

26. The powered device of claim 21, wherein the powered system comprises a power over Ethernet (PoE) network.
